(19) United States
(12) Patent Application Publication
(10) Pub. No.: US 2025/0062679 A1
(43) Pub. Date: Feb. 20, 2025

(54) POWER CONVERSION APPARATUS AND AIR CONDITIONER

(71) Applicant: Mitsubishi Electric Corporation, Tokyo (JP)

(72) Inventors: Yuki TANIYAMA, Tokyo (JP); Yosuke HACHIYA, Tokyo (JP); Kenta YUASA, Tokyo (JP); Akane HONGYO, Tokyo (JP); Yuichi SHIMIZU, Tokyo (JP); Atsushi TSUCHIYA, Tokyo (JP)

(73) Assignee: Mitsubishi Electric Corporation, Tokyo (JP)

(21) Appl. No.: 18/720,707

(22) PCT Filed: Dec. 27, 2021
(86) PCT No.: PCT/JP2021/048610

§ 371 Date: Jun. 17, 2024

(51) Int. Cl. H02M 1/12; H02M 7/219; H02M 7/5387; H02P 23/14; H02P 25/024; H02P 27/08

(52) U.S. Cl. CPC H02M 1/12; H02M 7/219; H02M 7/53871; H02P 23/14; H02P 25/024; H02P 27/08; H02P 2201/03

(57) ABSTRACT

A power conversion apparatus includes: a rectifying unit that rectifies an AC voltage input from an AC power supply to convert the AC voltage into a DC link voltage; a capacitor that is charged with a DC link voltage converted by the rectifying unit; a power application unit that converts the DC link voltage with which the capacitor is charged into an AC voltage by switching the DC link voltage, and outputs the AC voltage to a motor; and a control unit that controls the power application unit. The control unit controls the power application unit such that a second beat is superimposed on a motor current, the second beat having a second frequency different from a first beat having a first frequency included in the motor current and having at least one of an amplitude or a phase aligned with the first beat.

### FIELD

The present disclosure relates to a power conversion apparatus that performs frequency conversion and voltage conversion on power of an AC power supply and supplies the power to a load, and relates to an air conditioner.

### BACKGROUND

In power conversion apparatuses, due to a certain factor, a pulsation component (hereinafter, referred to as a beat) different from a driving frequency component of a motor may be included in a motor current that is output from an inverter and flows through the motor. The certain factor may be, for example, a case of applying an electrolytic capacitor-less inverter in which a large capacitance electrolytic capacitor is not provided for voltage smoothing in a DC link unit of the power conversion apparatus, and a small capacitance film capacitor or ceramic capacitor is provided to an extent that voltage pulsation is allowed. The electrolytic capacitor-less inverter has advantages in terms of a risk of a failure, a size, and a cost of the electrolytic capacitor, but does not smooth pulsation of a DC link voltage, and thus has a disadvantage that a beat is superimposed on the motor current, and vibration and noise are generated in the motor.

In Patent Literature 1, in an electrolytic capacitor-less inverter, in order to reduce a beat of an output current of the inverter, control is performed in which a phase of a combined voltage vector of two voltage vectors of a d-axis voltage vector and a q-axis voltage vector of a motor viewed from a q-axis is caused to pulsate in accordance with a pulsation component of a DC link unit.

### CITATION LIST

### Patent Literature

Patent Literature 1: Japanese Patent Application Laid-open No. 2013-85455

### SUMMARY OF INVENTION

### Problem to be Solved by the Invention

In Patent Literature 1, it is assumed that a phase of the q-axis voltage vector is freely controlled, but actually, there is an operation mode in which the q-axis voltage vector cannot be freely determined. For example, in an overmodulation operation in which a modulation rate for determining an output voltage of a power conversion apparatus exceeds 1, there is a timing at which the phase of the q-axis voltage vector cannot be freely determined. Therefore, in such an overmodulation operation, a beat remains in a current output from the inverter.

Further, in Patent Literature 1, it is possible to reduce a low frequency beat generated at a difference frequency obtained by an absolute value of subtraction between a pulsation frequency of the DC link voltage and a driving frequency of the motor. However, it is difficult to reduce a high frequency beat generated at a sum frequency obtained by adding the pulsation frequency of the DC link voltage to the driving frequency of the motor. When a motor current includes a beat, an amplitude of the motor current increases to cause noise and vibration during operation, and reliability of each element of the power conversion apparatus is impaired.

The present disclosure has been made in view of the above, and an object thereof is to obtain a power conversion apparatus capable of reducing a beat of a motor current and preventing an increase in amplitude of the motor current.

### Means to Solve the Problem

To solve the problem and achieve the object described above, a power conversion apparatus according to the present disclosure comprises: a rectifying unit to rectify an alternating-current voltage input from an alternating-current power supply to convert the alternating-current voltage into a direct-current link voltage; a capacitor to be charged with the direct-current link voltage converted by the rectifying unit; a power application unit to convert the direct-current link voltage with which the capacitor is charged into an alternating-current voltage by switching the direct-current link voltage, and output the alternating-current voltage to a load; and a control unit to control the power application unit. The control unit controls the power application unit such that a second beat is superimposed on a load current, the second beat having a second frequency different from a first beat having a first frequency included in the load current, and the second beat having at least one of an amplitude or a phase aligned with the first beat.

### Effects of the Invention

According to a power conversion apparatus of the present disclosure, it is possible to reduce a beat of a motor current and prevent an increase in amplitude of the motor current.

### BRIEF DESCRIPTION OF DRAWINGS

FIG. 1 is a circuit block diagram illustrating a configuration of a power conversion apparatus according to a first embodiment.

FIG. 2 is a diagram illustrating a current waveform when a low frequency beat is superimposed on a motor current of a motor, and a current waveform when a low frequency beat and a high frequency beat are superimposed on a motor current of the motor, in the power conversion apparatus according to the first embodiment.

FIG. 3 is a diagram illustrating a current waveform when a high frequency beat is superimposed on a motor current of the motor, and a current waveform when a high frequency beat and a low frequency beat are superimposed on a motor current of the motor, in the power conversion apparatus according to the first embodiment.

FIG. 4 is a circuit block diagram illustrating a configuration of a power conversion apparatus according to a second embodiment.

FIG. 5 is a control block diagram illustrating a configuration of a beat reduction controller according to the second embodiment.

FIG. 6 is a diagram illustrating waveforms of a DC link voltage, a motor current, and a pulsation phase in a case where there is no beat reduction controller in the power conversion apparatus according to the second embodiment.

FIG. 7 is a diagram illustrating waveforms of a DC link voltage, a motor current, and a pulsation phase in a case where there is the beat reduction controller in the power conversion apparatus according to the second embodiment.

FIG. 8 is a diagram illustrating a simulation waveform of a motor current and a frequency analysis result thereof in a case where a cancellation voltage calculator is not used in the power conversion apparatus according to the second embodiment.

FIG. 9 is a diagram illustrating a simulation waveform of a motor current and a frequency analysis result thereof in a case where the cancellation voltage calculator is used in the power conversion apparatus according to the second embodiment.

FIG. 10 is a schematic diagram illustrating a configuration of an air conditioner according to a third embodiment.

FIG. 11 is a diagram illustrating an example of a hardware configuration that implements a control unit of the first embodiment and a control unit of the second embodiment.

### DESCRIPTION OF EMBODIMENTS

Hereinafter, a power conversion apparatus according to embodiments will be described in detail with reference to the drawings. The power conversion apparatus according to the embodiments is applied to an electrolytic capacitor-less inverter.

### First Embodiment

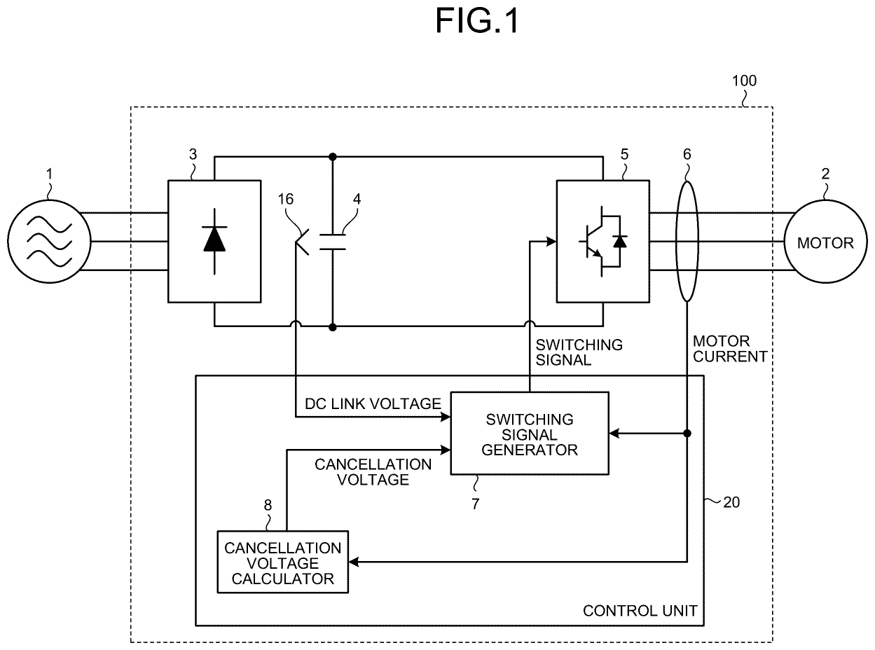

FIG. 1 is a circuit block diagram illustrating a configuration of a power conversion apparatus according to a first embodiment. In FIG. 1, an input side of a power conversion apparatus 100 is connected to an AC power supply 1, and an output side thereof is connected to a motor 2 as a load. The power conversion apparatus 100 converts power of the AC power supply 1 into any frequency and any voltage, and supplies the power to the motor 2 as a load. The AC power supply 1 is, for example, a three-phase commercial power supply, and the motor 2 is, for example, a permanent magnet synchronous motor. The power conversion apparatus 100 includes a rectifying unit 3, a capacitor 4, a power application unit 5, a current detecting unit 6, a voltage detecting unit 16, and a control unit 20. The power application unit 5 is, for example, an inverter. The control unit 20 includes a switching signal generator 7 and a cancellation voltage calculator 8.

The rectifying unit 3 rectifies an AC voltage input from the AC power supply 1 to convert the AC voltage into a DC voltage. The DC voltage rectified by the rectifying unit 3 includes a low-order harmonic component pulsating at a frequency six times a voltage frequency of the AC power supply 1. The rectifying unit 3 includes, for example, a full bridge circuit including six rectifying diodes. Note that, as the rectifying unit 3, a switching element such as a transistor may be used instead of the rectifying diode.

The capacitor 4 is connected to a DC link unit of the power conversion apparatus 100. The capacitor 4 is charged with the DC voltage converted by the rectifying unit 3. The DC link unit is a portion of a DC circuit of the power conversion apparatus 100. The purpose of the capacitor 4 is to smooth a DC link voltage, but a harmonic component may remain in the DC voltage rectified by the rectifying unit 3, depending on a capacitance of the capacitor 4. The DC link voltage is a voltage of a DC circuit connecting the rectifying unit 3 and the power application unit 5. In accordance with a capacitance of the capacitor 4, the DC link voltage has a harmonic component smoothed and a harmonic component that is not smoothed. A beat is superimposed on the motor current output from the power application unit 5 due to the harmonic component that is not smoothed. The voltage detecting unit 16 detects a voltage applied across the capacitor 4, that is, the DC link voltage.

The power application unit 5 converts the DC voltage rectified by the rectifying unit 3 into an AC voltage, and outputs the AC voltage to the motor 2. The power application unit 5 includes, for example, a full bridge circuit including six insulated gate bipolar transistors (IGBTs). Further, a reflux diode is connected in antiparallel to each IBGT. Each IGBT independently performs on/off operation in response to a switching signal output from the switching signal generator 7 described later. This on/off operation converts the DC voltage into the AC voltage. Note that the power application unit 5 may use a switching element such as a metal-oxide-semiconductor field-effect transistor (MOSFET) instead of the IGBT.

The current detecting unit 6 detects a motor current which is a load current flowing in the motor 2, and outputs the detected motor current. The current detecting unit 6 is, for example, a current sensor using a meter current transformer called a current transformer (CT). Note that, as the current detecting unit 6, it is also possible to use: a means called a one-shunt current detection system using a shunt resistor provided in a negative-side DC link unit of the power conversion apparatus 100; or a means called a three-shunt current detection system using a shunt resistor provided in series with a switching element on a lower side of the power application unit 5.

The cancellation voltage calculator 8 detects a frequency of a first beat superimposed on a motor current and at least one of an amplitude or a phase on the basis of a detection value of the motor current input from the current detecting unit 6, and calculates a cancellation voltage that allows reduction of the amplitude of the motor current by superimposing a beat having a second frequency different from the detected first beat. That is, the cancellation voltage calculator 8 calculates a second beat to be superimposed in which at least one of an amplitude or a phase is aligned with the detected first beat, and outputs a voltage command including the calculated second beat to the switching signal generator 7 as a cancellation voltage. Note that the cancellation voltage calculator 8 may output a cancellation current corresponding to the calculated cancellation voltage to the switching signal generator 7, or may output the cancellation voltage and the cancellation current to the switching signal generator 7.

On the basis of: an operation command such as a speed command or a torque command input from the outside; a motor current detected by the current detecting unit 6; a DC link voltage detected by the voltage detecting unit 16; and a cancellation voltage output from the cancellation voltage calculator 8, the switching signal generator 7 performs control calculation, and generates and outputs a switching signal for controlling on/off of a plurality of switching elements included in the power application unit 5. The switching signal generator 7 performs, for example, vector control of performing feedback control on a current flowing through the motor 2 by using a dq coordinate system, to control the speed and torque. The switching signal generator 7 converts a voltage command calculated in the dq coordinate system into a three-phase coordinate system including a U phase, a V phase, and a W phase. The switching signal generator 7 generates a pulse width modulation (PWM) signal for performing PWM control on the switching element of the power application unit 5, on the basis of the DC link voltage and the voltage command of the three-phase coordinate system. The switching signal generator 7 outputs the generated PWM signal to the power application unit 5. The switching signal generator 7 may perform V/f constant control of outputting a voltage proportional to an operation frequency of the motor 2, and direct torque control of controlling a magnetic flux and torque of the motor 2.

The switching signal generator 7 corrects the voltage command such that a beat current having the second frequency different from the beat current having the first frequency included in the motor current is superimposed on a load current, for example, by adding the cancellation voltage input from the cancellation voltage calculator 8 to the voltage command calculated in the dq coordinate system. Note that the switching signal generator 7 may correct a current command by using the cancellation voltage input from the cancellation voltage calculator 8 or the cancellation current.

A significance of correcting the voltage command by using the cancellation voltage will be described. By superimposing a beat having a frequency different from a beat included in a motor current, an increase in amplitude of the motor current due to the beat can be reduced. For example, a case is considered in which a capacitor voltage of the DC link unit pulsates and a current beat occurs in an output current of the inverter. As described above, when the AC power supply 1 is a three-phase AC, the capacitor voltage of the DC link unit pulsates at a frequency six times a voltage frequency of the AC power supply 1. At this time, a current beat having a frequency component of a difference between a pulsation frequency of the capacitor voltage and a driving frequency of the motor 2 and a current beat having a frequency component of a sum of these frequencies are superimposed on the motor current. The current beat of the frequency component of the difference is a frequency component lower than the driving frequency of the motor 2, and the current beat of the frequency component of the sum is a frequency component higher than the driving frequency of the motor 2. Therefore, these beats are referred to as a low frequency beat and a high frequency beat, respectively. The power conversion apparatus 100 according to the present disclosure proposes a means for preventing an increase in amplitude of the motor current when one or both of the low frequency beat and the high frequency beat are superimposed on the driving frequency of the motor 2. A plurality of methods for canceling the beats can be considered. For example, regarding a component of a low frequency beat included in a motor current, it is conceivable to calculate at least one of an amplitude or a phase by using a certain method, and superimpose a high frequency beat in which at least one of the amplitude or the phase is aligned with that obtained by the calculation. Here, as the certain method, for example, it is conceivable to use a technique using Fourier series expansion or a bandpass filter. This similarly applies to a case where a high frequency beat is canceled by a low frequency beat. As another method, a low frequency beat and a high frequency beat may be canceled by aligning at least one of amplitudes or phases of pulsation components included in a d-axis current and a q-axis current. When a capacitor voltage of the DC link unit is pulsating, the d-axis current and the q-axis current pulsate at a frequency identical to a pulsation frequency of the capacitor voltage. At this time, by aligning at least one of amplitudes or phases with respect to components having a frequency identical to the pulsation frequency of the capacitor voltage included in the d-axis current and the q-axis current, at least one of amplitudes or phases of the low frequency beat and the high frequency beat of the motor current can be aligned when considered in the UVW axes, so that the current beat can be canceled.

First, it will be described that, while a low frequency beat is superimposed on the motor current of the motor 2, an increase in current amplitude can be reduced by newly superimposing a high frequency beat in which at least one of an amplitude or a phase is aligned with the low frequency beat. The state in which the amplitudes are aligned means not only a state in which the amplitudes are equal, but also a state in which the amplitudes are different to some extent as long as an increase in current amplitude can be reduced. The state in which the phases are aligned includes not only a state in which the phases are equal to each other but also a state in which the phases are different to some extent as long as an increase in current amplitude can be reduced. Since the motor current can be expressed by addition of sine waves, general addition of sine waves is considered. A driving frequency component of the motor 2 is defined as Asin (ω₁t), and a low frequency beat is defined as Bsin {(ω_{b}-ω₁)t+α}. Here, reference character “A” is an amplitude of a driving frequency component of the motor 2, reference character “B” is an amplitude of the low frequency beat, reference character “ω₁” is a driving frequency of the motor 2, reference character “ω_{b}” is a pulsation frequency of the DC link voltage, and reference character “α” is a phase of the low frequency beat with respect to the driving frequency component of the motor 2. In this way, the high frequency beat in which at least one of the amplitude or the phase is aligned with the low frequency beat is assumed to be superimposed while the low frequency beat is superimposed on the motor current of the motor 2. When the high frequency beat is assumed to be Bsin {(ω_{b}+ω₁)t+α}, the motor current can be expressed by the following Equation (1) using a sum product formula or the like.

$$\begin{matrix}Formula 1 & \\ Driving frequency component of motor + Low frequency beat + High frequency beat = A sin ( {ω}_{i} t ) + B sin \{ ( {ω}_{b} - {ω}_{t} ) t + α \} + B sin \{ ( {ω}_{b} + {ω}_{i} ) t + α \} = A sin ( {ω}_{i} t ) + B \times \frac{1}{2} \times \{ sin ( {ω}_{b} t + α ) cos ( {ω}_{i} t ) \} = A sin ( {ω}_{i} t ) + \frac{B sin ( {ω}_{b} t )}{2} sin ( {ω}_{i} + \frac{π}{2} ) = \sqrt{{A}^{2} + {\{ \frac{B sin ( {ω}_{b} t )}{2} \}}^{2}} sin ( {ω}_{i} t + ϕ ) & \end{matrix}$$

$$\begin{matrix}Formula 2 & \\ P = \frac{B sin ( {ω}_{b} t )}{2} sin ( {ω}_{i} + \frac{π}{2} ) \\ Q = \sqrt{{A}^{2} {\{ \frac{B sin ( {ω}_{b} t )}{2} \}}^{2}} & \end{matrix}$$

When P and Q are defined as in the above equation, reference character “φ” is a phase change that occurs when Asin (ω₁t) and P are added. Here, when the magnitude of B is sufficiently small with respect to A, approximation can be performed as in the following Equation (2).

$$\begin{matrix}Formula 3 & \\ \sqrt{{A}^{2} + {\{ \frac{B sin ( {ω}_{b} t )}{2} \}}^{2}} sin ( {ω}_{i} t + ϕ ) ≅ {A}^{2} sin ( {ω}_{i} t + ϕ ) & ( 2 )\end{matrix}$$

Specifically, approximation can be performed when the amplitude B of the low frequency beat is as small as about 1/10 of the amplitude A of the driving frequency component of the motor 2. For example, when A=50 and B=5, reference character “Q” is at most 50.0625 and at least 49.9375, and thus can be considered as about 50. As described above, while a low frequency beat is superimposed on the motor current, it is possible to reduce an increase in current amplitude due to the low frequency beat, by superimposing a high frequency beat having an amplitude and a phase aligned with the low frequency beat.

Next, while a low frequency beat is superimposed on the motor current, it is confirmed from a time-series waveform that the current amplitude can be reduced by superimposing the high frequency beat. For example, when the driving frequency component of the motor is assumed to be Asin (ω₁t)=50 sin (357×2πt) and the low frequency beat is assumed to be Bsin {(ω_{b}−ω₁)t+α}=5 sin {(360−357)×2πt}=5 sin (3×2πt), sine waves are superimposed. At this time, the high frequency beat is assumed to be Bsin {(ω_{b}+ω₁)t+α}=5 sin {(360+357)×2πt}=5 sin (717×2πt) in which at least one of an amplitude or a phase is aligned with the low frequency beat.

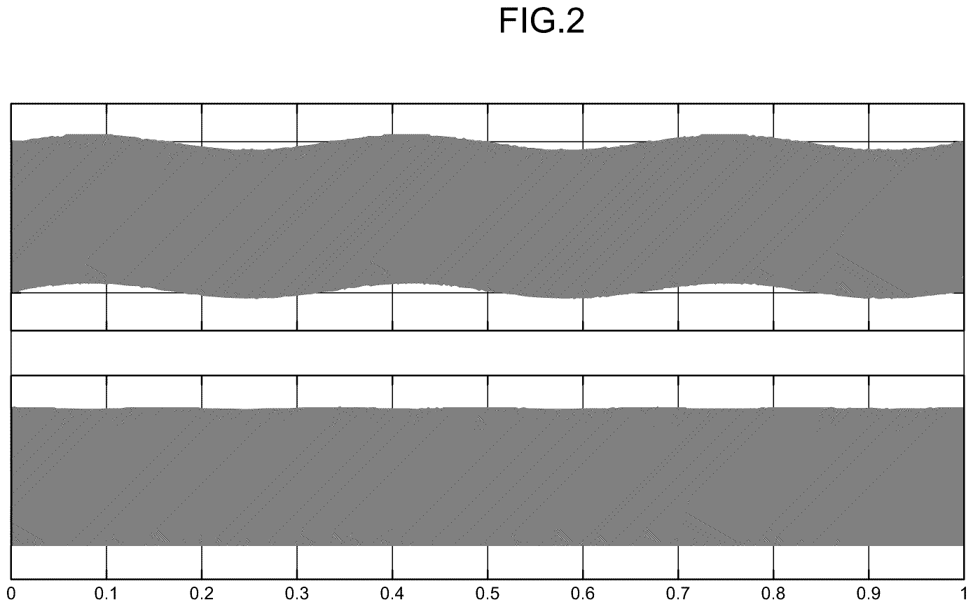

FIG. 2 is a diagram illustrating a current waveform when a low frequency beat is superimposed on a motor current of the motor 2, and a current waveform when a low frequency beat and a high frequency beat are superimposed on a motor current of the motor 2, in the power conversion apparatus 100 of the first embodiment. A waveform on the upper side in FIG. 2 is a current waveform when a low frequency beat is superimposed on a motor current of the motor 2, and is a waveform of 50 sin (357×2πt)+5 sin (3×2πt). A waveform on the lower side of FIG. 2 is a current waveform when a low frequency beat and a high frequency beat are superimposed on a motor current of the motor 2, and is a waveform of 50 sin (357×2πt)+5 sin (3×2πt)+5 sin (717×2πt). It can be seen that the beat is reduced and the amplitude is smaller in the waveform on the lower side than in the waveform on the upper side. In this manner, an increase in current peak due to the low frequency beat can be canceled by the high frequency beat.

This similarly applies to a case where a low frequency beat is superimposed while a high frequency beat is superimposed on a motor current. For example, when the driving frequency component of the motor 2 is assumed to be Asin (ω₁t)=50 sin (357×2πt) and the high frequency beat is assumed to be Bsin {(ω_{b}+ω₁)t+α}=5 sin {(360+357)×2πt}=5 sin (717×2πt), sine waves are superimposed. At this time, the low frequency beat is assumed to be Bsin {(ω_{b}−ω₁)t+α}=5 sin {(360−357)×2πt}=5 sin (3×2πt).

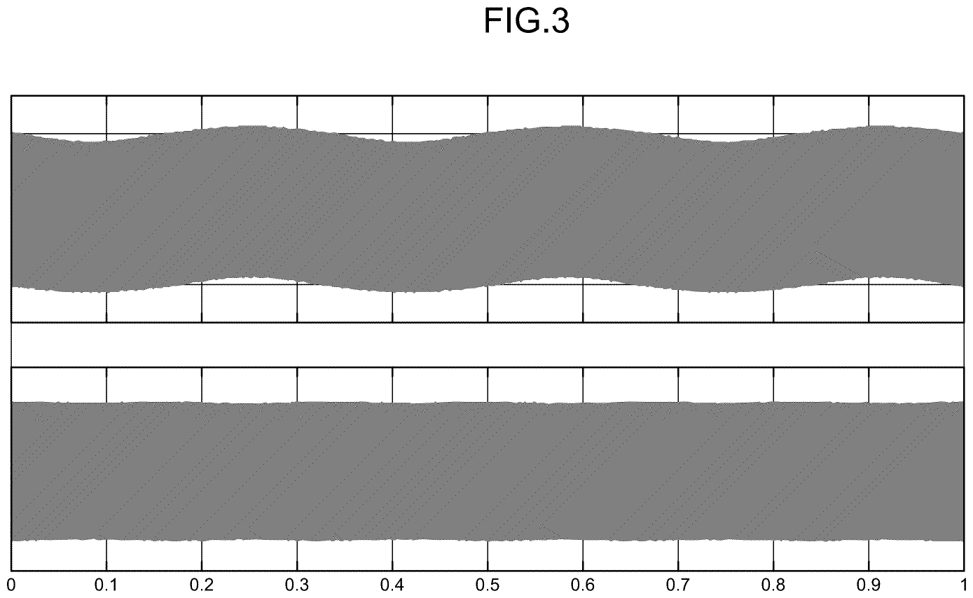

FIG. 3 is a diagram illustrating a current waveform when a high frequency beat is superimposed on a motor current of the motor 2, and a current waveform when a high frequency beat and a low frequency beat are superimposed on a motor current of the motor 2, in the power conversion apparatus 100 according to the first embodiment. A waveform on the upper side in FIG. 3 is a current waveform when a high frequency beat is superimposed on a motor current of the motor 2, and is a waveform of 50 sin (357×2πt)+5 sin (717×2πt). The waveform on the lower side of FIG. 3 is a current waveform when a high frequency beat and a low frequency beat are superimposed on a motor current of the motor 2, and is a waveform of 50 sin (357×2πt)+5 sin (717×2πt)+5 sin (3×2πt). It can be seen that the beat is reduced and the amplitude is smaller in the waveform on the lower side than in the waveform on the upper side. In this manner, an increase in current peak due to the high frequency beat can be canceled by the low frequency beat.

As described above, the cancellation voltage calculator 8 has a function of calculating a high frequency beat or a low frequency beat in which at least one of an amplitude or a phase is aligned with a low frequency beat or a high frequency beat included in a motor current, in accordance with the low frequency beat or the high frequency beat included in the motor current. For this purpose, the cancellation voltage calculator 8 needs to detect a frequency of a beat included in the motor current and at least one of an amplitude or a phase. A plurality of methods are conceivable for detecting at least one of the amplitude or the phase of the beat included in the motor current. For example, detection may be performed using a bandpass filter, calculation may be performed by subtracting a value detected using a notch filter from the original motor current, or detection may be performed using Fourier series expansion.

In accordance with the detected low frequency beat or high frequency beat, the cancellation voltage calculator 8 determines a high frequency beat or a low frequency beat to be superimposed in which at least one of an amplitude or a phase is aligned with the detected low frequency beat or high frequency beat, and outputs a voltage command including the determined high frequency beat or low frequency beat to the switching signal generator 7 as a cancellation voltage. By adding the cancellation voltage input from the cancellation voltage calculator 8 to the voltage command, the switching signal generator 7 corrects the voltage command such that a high frequency beat in which at least one of an amplitude or a phase is aligned with a low frequency beat is superimposed in a case where the motor current includes the low frequency beat, and a low frequency beat in which at least one of an amplitude or a phase is aligned with a high frequency beat is superimposed in a case where the motor current includes the high frequency beat.

As described above, in the first embodiment, a voltage command is corrected such that a high frequency beat in which at least one of an amplitude or a phase is aligned with a low frequency beat is superimposed in a case where the motor current includes the low frequency beat, and a low frequency beat in which at least one of an amplitude or a phase is aligned with a high frequency beat is superimposed in a case where the motor current includes the high frequency beat. Therefore, it is possible to operate the motor 2 while preventing an increase in amplitude of the motor current. Therefore, noise and vibration during operation can be prevented. Furthermore, by preventing an increase in amplitude of the current, reliability of each element of the power conversion apparatus 100 can be improved.

### Second Embodiment

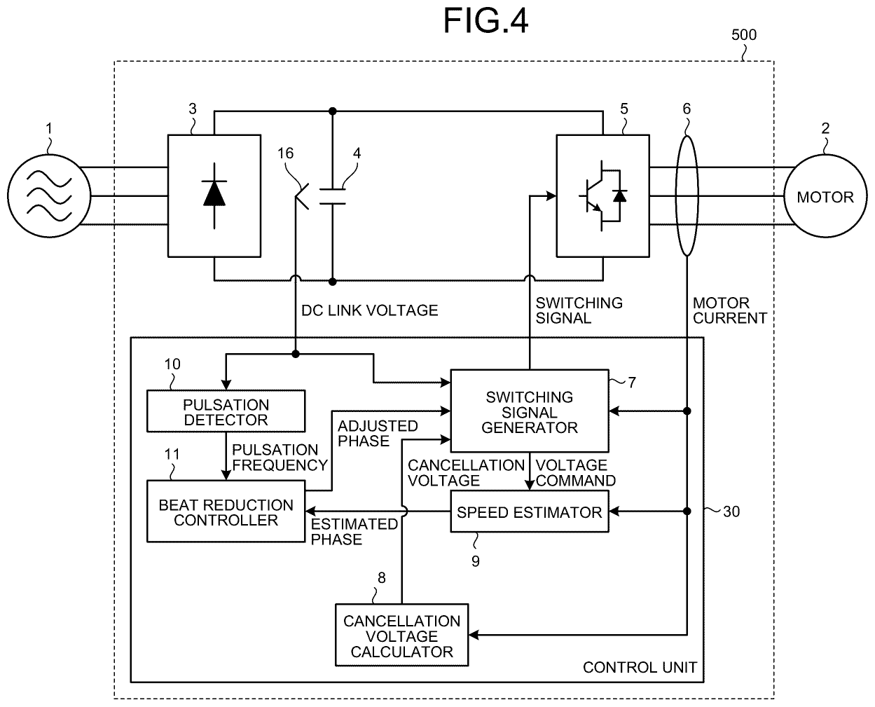

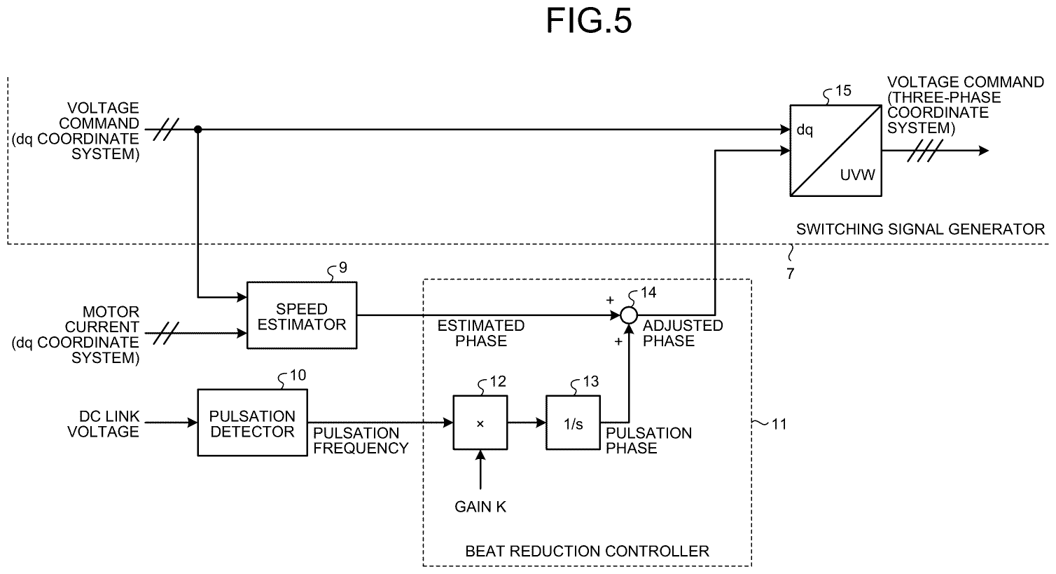

In a second embodiment, in order to further prevent an increase in amplitude of the motor current, an operational effect of a beat reduction controller 11 is improved using the cancellation voltage calculator 8. FIG. 4 is a circuit block diagram illustrating a configuration of a power conversion apparatus according to the second embodiment. FIG. 5 is a control block diagram illustrating a configuration of the beat reduction controller 11 according to the second embodiment.

In a power conversion apparatus 500 of the second embodiment illustrated in FIG. 4, a speed estimator 9, a pulsation detector 10, and the beat reduction controller 11 are added to the configuration of FIG. 1. In addition, the control unit 20 is replaced with a control unit 30.

The speed estimator 9 estimates a rotational speed and a magnetic pole position of a rotor of the motor 2, on the basis of a detection value of a motor current which is an output value of the current detecting unit 6 and on the basis of a voltage command input from the switching signal generator 7. As a method of estimation, it is common to calculate from a speed electromotive force of the motor 2. For example, there are a method called an arctangent method and a method called an adaptive flux observer system. The speed estimator 9 outputs the estimated magnetic pole position, that is, an estimated phase to the beat reduction controller 11.

The pulsation detector 10 detects a pulsation frequency on the basis of a DC link voltage detected by the voltage detecting unit 16, and outputs the detected pulsation frequency to the beat reduction controller 11. As described above, since the capacitor 4 has a small capacitance, the DC link voltage pulsates at a frequency about six times a voltage frequency of the AC power supply 1. The pulsation detector 10 accurately obtains the pulsation frequency of the DC link voltage. As a technique of obtaining the pulsation frequency, for example, there are a method of causing the detected value of the DC link voltage to pass through a bandpass filter, and a method of subtracting a result of causing the value of the DC link voltage to pass through a notch filter from an original value of the DC link voltage.

The beat reduction controller 11 adjusts an estimated phase output from the speed estimator 9 so as to reduce pulsation of the motor current. As illustrated in FIG. 5, the beat reduction controller 11 includes a gain imparting unit 12, an integrator 13, and an adder 14. The gain imparting unit 12 multiplies a pulsation frequency, which is an output value of the pulsation detector 10, by a gain K. The integrator 13 integrates an output of the gain imparting unit 12. The adder 14 adds an estimated phase, which is an output value of the speed estimator 9, to an output of the integrator 13 to calculate an adjusted phase. The beat reduction controller 11 outputs the calculated adjusted phase to the switching signal generator 7. The gain K may simply be determined according to a voltage frequency of the AC power supply 1 and magnitude of the DC link voltage. The gain K may be a fixed value determined in advance, or may be a variable value depending on states of the AC power supply 1 and the motor 2.

The switching signal generator 7 includes a dq three-phase coordinate conversion unit 15. The switching signal generator 7 changes an adjusted phase, which is an output value of the beat reduction controller 11, by using a cancellation voltage of the cancellation voltage calculator 8, and converts the voltage command calculated in the dq coordinate system into a UVW three-phase coordinate system, in accordance with the changed adjusted phase.

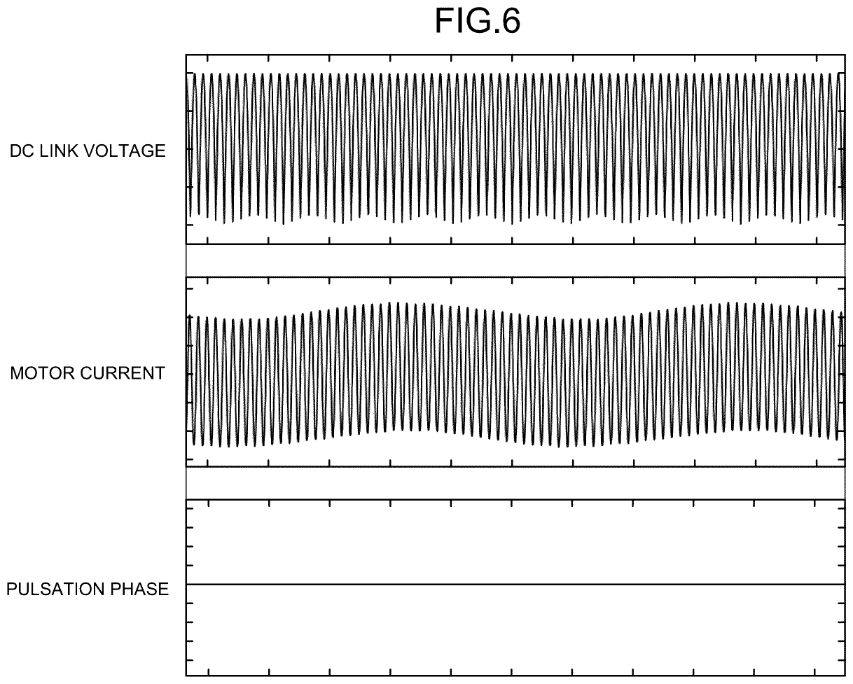

Here, a significance of the beat reduction controller 11 will be described. FIG. 6 is a diagram illustrating waveforms of a DC link voltage, a motor current, and a pulsation phase in a case where there is no beat reduction controller 11 in the power conversion apparatus 500 of the second embodiment. A horizontal axis represents time. The DC link voltage includes a pulsation component. In a case where there is no beat reduction controller 11, the switching signal generator 7 performs coordinate conversion from the dq coordinate system to the three-phase coordinate system, by using an estimated phase estimated by the speed estimator 9. In this case, since a voltage applied to the motor 2 is affected by the pulsation component of the DC link voltage, a beat is superimposed on a motor current flowing through the motor 2. In particular, when an operation frequency of the motor 2 is close to a pulsation frequency of the DC link voltage, a large current beat appears.

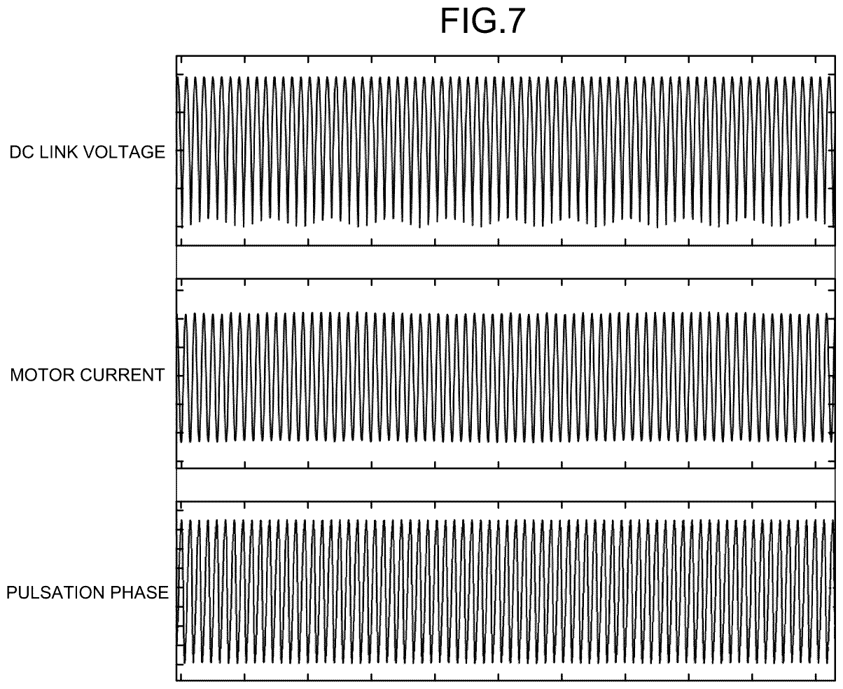

FIG. 7 is a diagram illustrating waveforms of a DC link voltage, a motor current, and a pulsation phase in a case where there is the beat reduction controller 11 in the power conversion apparatus 500 of the second embodiment. When there is the beat reduction controller 11, the switching signal generator 7 performs coordinate conversion between the dq coordinate system and the three-phase coordinate system, by using an adjusted phase calculated by the beat reduction controller 11. In this case, since an influence of the pulsation component of the DC link voltage can be canceled from a voltage applied to the motor 2, a beat of the current flowing through the motor 2 can be reduced.

However, even if the beat reduction controller 11 is used, there is a case where a low frequency beat remains. Even in such a case, if the cancellation voltage calculator 8 is present, an amplitude of the motor current can be reduced using a high frequency beat. As described above, for example, when the DC link voltage pulsates at a frequency six times a frequency of the AC power supply 1, both the low frequency beat and the high frequency beat are superimposed on the motor current. However, the low frequency beat and the high frequency beat cannot be canceled in a case where at least one of amplitudes or phases are not aligned, as shown in Equations (1) and (2). Therefore, the amplitude of the motor current greatly increases under the influence of both the low frequency beat and the high frequency beat. In the second embodiment, by changing the adjusted phase calculated by the beat reduction controller 11 by using a cancellation voltage of the cancellation voltage calculator 8, at least one of the amplitudes or the phases of the low frequency beat and the high frequency beat superimposed on the motor current can be adjusted to be aligned.

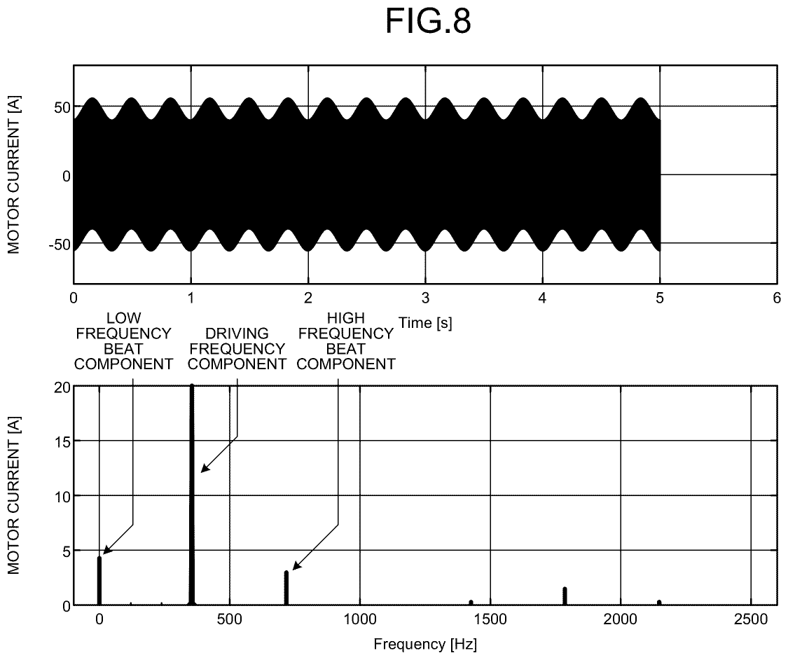

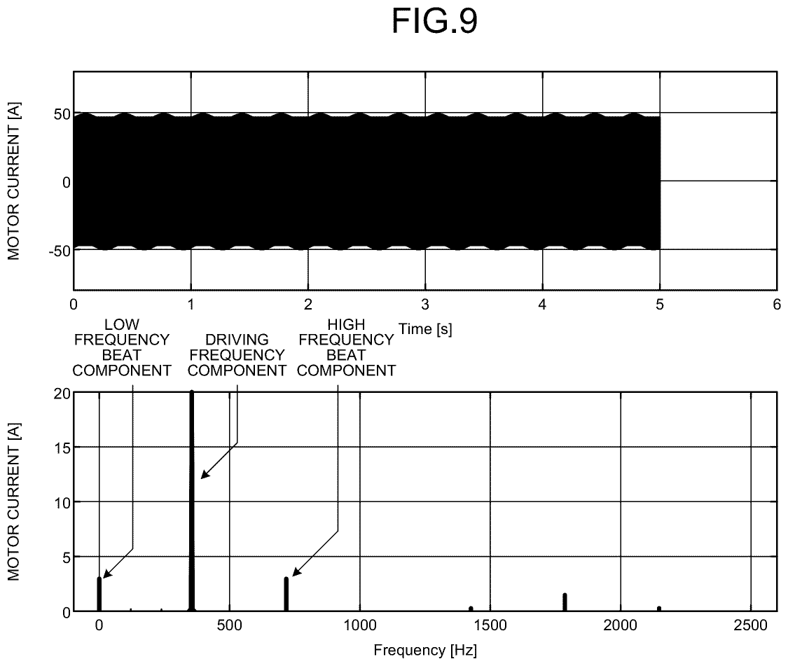

FIG. 8 is a diagram illustrating a simulation waveform of a motor current and a frequency analysis result thereof in a case where the cancellation voltage calculator 8 is not used in the power conversion apparatus 500 according to the second embodiment. An upper view of FIG. 8 illustrates a simulation waveform of a motor current, and a lower view of FIG. 8 illustrates a frequency analysis result of the simulation waveform of the motor current. Further, FIG. 9 is a diagram illustrating a simulation waveform of a motor current and a frequency analysis result thereof in a case where the cancellation voltage calculator 8 is used in the power conversion apparatus 500 of the second embodiment. An upper view of FIG. 9 illustrates a simulation waveform of a motor current, and a lower view of FIG. 9 illustrates a frequency analysis result of the simulation waveform of the motor current.

As illustrated in FIGS. 8 and 9, it can be seen that an increase in amplitude of the motor current is reduced in the case of using the cancellation voltage calculator 8, as compared with the case of not using the cancellation voltage calculator 8. As can be seen from the frequency analysis result, there is no significant difference between a low frequency beat component and a high frequency beat component in both the case of not using the cancellation voltage calculator 8 and the case of using the cancellation voltage calculator 8. Nevertheless, the amplitude of the motor current is reduced to be smaller in the case of using the cancellation voltage calculator 8 because adjustment is performed such that at least one of amplitudes or phases of the low frequency beat and the high frequency beat are aligned in the case of using the cancellation voltage calculator 8.

In this way, according to the second embodiment, since the adjusted phase of the beat reduction controller 11 is changed by the output from the cancellation voltage calculator 8, the amplitude of the motor current can be reduced to be smaller.

### Third Embodiment

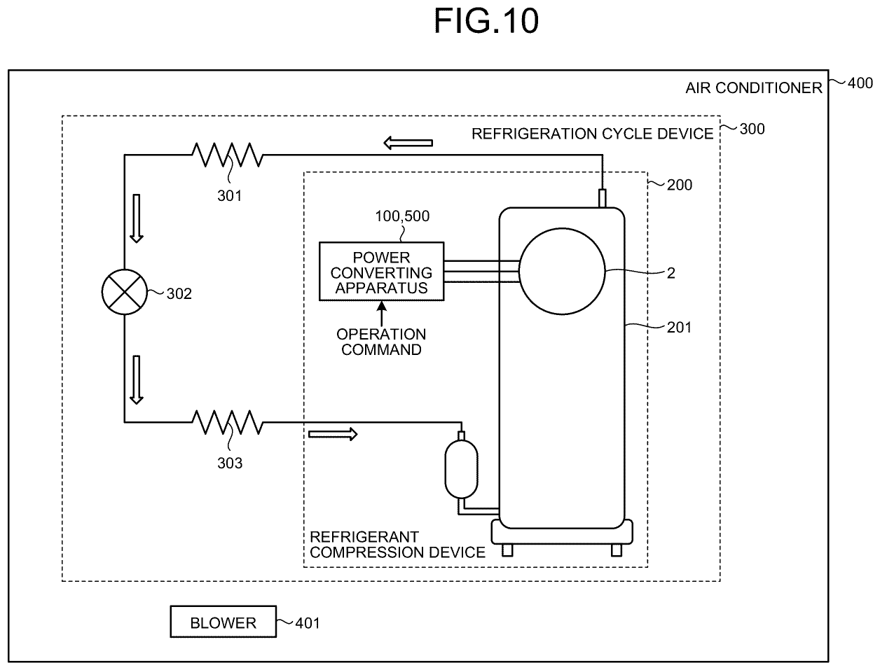

In a third embodiment, the power conversion apparatus 100 of the first embodiment or the power conversion apparatus 500 of the second embodiment is applied to an air conditioner. FIG. 10 is a schematic diagram illustrating a configuration of an air conditioner according to the third embodiment. An air conditioner 400 includes a refrigeration cycle device 300 and a blower 401. The refrigeration cycle device 300 includes a refrigerant compression device 200, a condenser 301, an expansion valve 302, and an evaporator 303. The refrigerant compression device 200 includes a compressor 201 and the power conversion apparatus 100 of the first embodiment or the power conversion apparatus 500 of the second embodiment.

As illustrated in FIG. 10, the compressor 201 and the condenser 301 are connected by piping. Similarly, the condenser 301 and the expansion valve 302, the expansion valve 302 and the evaporator 303, and the evaporator 303 and the compressor 201 are connected by piping. As a result, a refrigerant circulates through the compressor 201, the condenser 301, the expansion valve 302, and the evaporator 303.

The motor 2 illustrated in FIG. 10 is a motor that is subjected to variable speed control by the power conversion apparatus 100 or 500 in order to compress refrigerant gas into high-pressure gas in the compressor 201. In the refrigeration cycle device 300, processes of evaporation, compression, condensation, and expansion of the refrigerant are repeatedly performed. The refrigerant changes from liquid to gas, and further changes from gas to liquid, whereby heat is exchanged between the refrigerant and outside air. Therefore, the air conditioner 400 can be configured by combining the refrigeration cycle device 300 and the blower 401 that circulates the outside air.

For example, in a case where the motor 2 of the compressor 201 is driven using an electrolytic capacitor-less inverter, if the beat reduction controller 11 is not provided, a large current beat appears when an operation frequency of the motor 2 and a pulsation frequency of a DC link voltage are close to each other. As a result, vibration and noise are generated from the compressor 201 or the piping connected to the compressor 201, and comfort of a user of the air conditioner 400 is impaired. Moreover, since pulsation is applied to an amount of work done by the motor 2, compression efficiency of the refrigerant gas also decreases. Further, when operating while avoiding an operation frequency at which the current beat is generated, the refrigeration cycle device 300 cannot operate optimally, which leads to a decrease in cycle efficiency.

However, even when the power conversion apparatus 100 or 500 applied to the air conditioner 400 is an electrolytic capacitor-less inverter, it is possible to provide the air conditioner 400 that is inexpensive, comfortable, and highly efficient, by providing the beat reduction controller 11 and the cancellation voltage calculator 8.

In the third embodiment, since the beat reduction controller 11 and the cancellation voltage calculator 8 are included, the operation can be performed without avoiding the operation frequency at which the current beat occurs, and an operation area is widened. In addition, vibration and noise can be reduced without addition of an unnecessary configuration through piping. Therefore, in addition to the effects of the first and second embodiments, it is possible to achieve efficient operation of the air conditioner 400.

Meanwhile, in the above description, the air conditioner 400 has been described as an application example of the power conversion apparatuses 100 and 500, but it is obvious that the power conversion apparatuses 100 and 500 can also be used for other machines. For example, the power conversion apparatus of the present application may be applied to a mechanical device such as a fan or a pump.

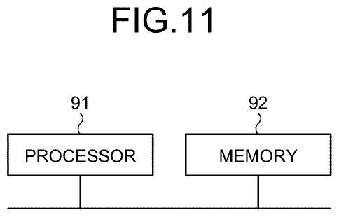

Next, hardware configurations of the control unit 20 of the first embodiment and the control unit 30 of the second embodiment will be described. FIG. 11 is a diagram illustrating an example of a hardware configuration that implements the control unit 20 of the first embodiment and the control unit 30 of the second embodiment. The control units 20 and 30 are implemented by a processor 91 and a memory 92.

The processor 91 is a central processing unit (CPU) (may also be referred to as a central processing device, a processing unit, an arithmetic unit, a microprocessor, a microcomputer, a processor, or a digital signal processor (DSP)) or a system large scale integration (LSI). The memory 92 can be exemplified by a nonvolatile or volatile semiconductor memory such as a random access memory (RAM), a read only memory (ROM), a flash memory, an erasable programmable read only memory (EPROM), or an electrically erasable programmable read-only memory (EEPROM) (registered trademark). In addition, the memory 92 is not limited thereto, and may be a magnetic disk, an optical disk, a compact disk, a mini disk, or a digital versatile disc (DVD).

The configurations illustrated in the above embodiments illustrate one example of the contents of the present disclosure and can be combined with another known technique, and it is also possible to omit and change a part of the configuration without departing from the subject matter of the present disclosure.

### REFERENCE SIGNS LIST

1 AC power supply; 2 motor; 3 rectifying unit; 4 capacitor; 5 power application unit; 6 current detecting unit; 7 switching signal generator; 8 cancellation voltage calculator; 9 speed estimator; 10 pulsation detector; 11 beat reduction controller; 12 gain imparting unit; 13 integrator; 14 adder; 15 dq three-phase coordinate conversion unit; 16 voltage detecting unit; 20, 30 control unit; 91 processor; 92 memory; 100, 500 power conversion apparatus; 200 refrigerant compression device; 201 compressor; 300 refrigeration cycle device; 301 condenser; 302 expansion valve; 303 evaporator; 400 air conditioner; 401 blower.

1. A power conversion apparatus comprising:
a rectifier to rectify an alternating-current voltage input from an alternating-current power supply to convert the alternating-current voltage into a direct-current link voltage;
a capacitor to be charged with the direct-current link voltage converted by the rectifier;
a power applier to convert the direct-current link voltage with which the capacitor is charged into an alternating-current voltage by switching the direct-current link voltage, and output the alternating-current voltage to a load; and
a power-applier controller to control the power applier, wherein
the power-applier controller controls the power applier such that a second beat is superimposed on a load current, the second beat having a second frequency different from a first beat having a first frequency included in the load current, and the second beat having at least one of an amplitude or a phase aligned with the first beat.

2. The power conversion apparatus according to claim 1, wherein
the power-applier controller includes:
a cancellation voltage calculator to detect at least one of an amplitude or a phase of a first beat included in the load current, calculate a second beat in which at least one of an amplitude or a phase is aligned with the detected first beat, and output a voltage command including the calculated second beat as a cancellation voltage; and
a switching signal generator to correct a command value such that the second beat is superimposed, based on a cancellation voltage input from the cancellation voltage calculator.

3. The power conversion apparatus according to claim 2, wherein, in a case where the first beat is a low frequency beat, the cancellation voltage calculator calculates, as the second beat, a high frequency beat in which at least one of an amplitude or a phase is aligned with the low frequency beat, and outputs the voltage command including the calculated second beat to the switching signal generator as the cancellation voltage.

4. The power conversion apparatus according to claim 2, wherein, in a case where the first beat is a high frequency beat, the cancellation voltage calculator calculates, as the second beat, a low frequency beat in which at least one of an amplitude or a phase is aligned with the high frequency beat, and outputs the voltage command including the calculated second beat to the switching signal generator as the cancellation voltage.

5. The power conversion apparatus according to claim 3, wherein a frequency of the low frequency beat is a frequency of a difference between a driving frequency of the load and a pulsation frequency of the direct-current link voltage, and a frequency of the high frequency beat is a frequency of a sum of a driving frequency of the load and a pulsation frequency of the direct-current link voltage.

6. The power conversion apparatus according to claim 2, wherein
the power-applier controller further includes:
a speed estimator to obtain an estimated phase of the load based on the load current;
a pulsation detector to detect a pulsation frequency based on the DC link voltage; and
a beat reduction controller to adjust an estimated phase output from the speed estimator so as to reduce pulsation of the load current, and output an adjusted phase, and
the switching signal generator corrects a command value such that the second beat is superimposed, based on an adjusted phase input from the beat reduction controller and a cancellation voltage input from the cancellation voltage calculator.

7. An air conditioner comprising: the power conversion apparatus according to claim 1; a refrigeration cycle device; and a blower.

8. The power conversion apparatus according to claim 4, wherein a frequency of the low frequency beat is a frequency of a difference between a driving frequency of the load and a pulsation frequency of the direct-current link voltage, and a frequency of the high frequency beat is a frequency of a sum of a driving frequency of the load and a pulsation frequency of the direct-current link voltage.
